(19) United States
(12) Patent Application Publication
(10) Pub. No.: US 2025/0103418 A1
(43) Pub. Date: Mar. 27, 2025

(54) SIGNAL FILTERING TOOL FOR PROBLEM TROUBLESHOOTING

(71) Applicant: Sumo Logic, Inc., Redwood City, CA (US)

(72) Inventor: Greg Nudelman, Redwood City, CA (US)

(21) Appl. No.: 18/473,704

(22) Filed: Sep. 25, 2023

(51) Int. Cl. G06F 11/07; G06F 9/451; G06F 9/54

(52) U.S. Cl. CPC G06F 11/0781; G06F 9/451; G06F 9/542; G06F 11/0709

(57) ABSTRACT

A filtering tool identifies relevant signals associated with a given event (e.g., an alert) to facilitate analysis and decision-making for problem resolution. Users select the problem to be analyzed and the tool assists to determine the cause of the problem by analyzing, not only the events associated with an alert, but also other potential correlated events. The tool allows the adjustment of correlation parameters to present the desired information and offers options to focus on alert-related events, e.g., problems occurring simultaneously in other similar machines. The tool provides faceted search filters, which enable users to refine their search results based on configurable criteria. The inclusion of multiple filter types provides flexibility and enhances the user experience by facilitating easy refinement of search results.

### TECHNICAL FIELD

The subject matter disclosed herein generally relates to methods, systems, and machine-readable storage media for a filtering tool select relevant information when diagnosing a problem in the presence of a large amount of data for analysis.

### BACKGROUND

Engineers are tasked with troubleshooting issues in production environments and finding solutions to recover from malfunctions quickly, having to investigate issues and identify their root causes, which requires deep knowledge about production systems, troubleshooting tools, and diagnosis experience.

Problems are often detected when alerts are triggered by the monitoring systems that inform about problems with computers, services, or applications associated with the company products and services. Typically, alerts are generated when the value of a metric goes above or below threshold values (e.g., CPU utilization, amount of memory available).

However, troubleshooting often requires expertise, as the amount of information available to troubleshoot may be overwhelming.

### BRIEF DESCRIPTION OF THE DRAWINGS

Various of the appended drawings merely illustrate example embodiments of the present disclosure and cannot be considered as limiting its scope.

FIG. 1 is a user interface (UI) showing a list of alerts, according to some example embodiments.

FIG. 2 is UI showing a list of events associated with an alert, according to some example embodiments.

FIG. 3 is a window of the UI showing a detailed comparison of events of interest, according to some example embodiments.

FIG. 4 is a UI showing the extended option to present additional events of interest, according to some example embodiments.

FIG. 5 is a UI showing the artificial intelligence (AI) option to show events of interest, according to some example embodiments.

FIG. 6 is the AI-option UI after changing the score threshold, according to some example embodiments.

FIG. 7 is the AI-option UI after changing some of the filters, according to some example embodiments.

FIG. 8 is a UI showing a different layout for presenting events, according to some example embodiments.

FIG. 9 is a flowchart of a method for providing the UI with multiple types of filters, according to some example embodiments.

FIG. 10 illustrates an embodiment of an environment in which machine data collection and analysis is performed.

FIG. 11 shows architectural details of the query engine, according to some example embodiments.

FIG. 12 is a flowchart of a method for providing a versatile tool for filtering signals to assist in problem resolution, according to some example embodiments.

FIG. 13 is a block diagram illustrating an example of a machine upon or by which one or more example process embodiments described herein may be implemented or controlled.

### DETAILED DESCRIPTION

Example methods, systems, and computer programs are directed to providing a versatile tool for filtering signals to assist in problem resolution. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Embodiments address the problem of managing and correlating disparate signals in the field of security. A search and filtering tool is presented, also referred to herein simply as the filtering tool or the filter tool. The filtering tool identifies relevant signals associated with a given event (e.g., an alert), facilitating efficient analysis and decision-making for problem resolution.

The filtering tool allows for the customization of correlation parameters to effectively capture desired information. Users can select the problem to analyze, and the tool will assist to determine the root cause of the problem by analyzing, not only the events associated with an alert, but also other correlated events.

The filtering tool allows users to adjust the correlation parameters and capture the desired information. The tool also offers options to focus on alert-related events or view events that may assist in understanding the root cause of the problem, e.g., problems occurring simultaneously in other similar machines. Further yet, the tool provides faceted search filters, which enable users to refine their search results based on specific criteria. These filters can be implemented, for example, as checkboxes or single-click options to allow the user to change filter criteria quickly and easily. The inclusion of multiple filter types provides flexibility and enhances the user experience by facilitating easy refinement of search results.

In one aspect, the tool provides three selection modes: exact match, extended match, and AI match. The exact match mode utilizes a signal as a filtering mechanism to narrow down a list of alerts. The extended match mode expands on the filtering process by considering additional entities and relationships. The AI match mode utilizes artificial intelligence to select events related to the problem being investigated.

Embodiments present information about time differences between alerts. The method involves determining the chronological order of events within a certain timeframe (e.g., 24-hour period) and identifying the event that triggered the alert. Further, the tool generates a summary graph that represents the behavior of an alert.

One general aspect includes a computer-implemented method that includes an operation for providing a first user interface (UI) presenting one or more alerts related to log data received by an analysis platform. Further, the met5hod includes an operation for, in response to a selection of an alert, providing a second UI. The second UI comprises one or more related alerts and a plurality of filters for selecting the one or more related alerts. The second UI comprises: a first option, with a filter set and entity filters, for presenting the related alerts, a second option, with the filter set, the entity filters and expansion parameters, for presenting the related alerts, wherein the expansion parameters add related alerts that are associated with information of the selected alert; and a third option, with the filter set, the entity filters and artificial intelligence (AI) filters, for presenting the related alerts; the AI filters providing matching scores for the related alerts, wherein the second UI shows related alerts with a match score greater than or equal to a score threshold.

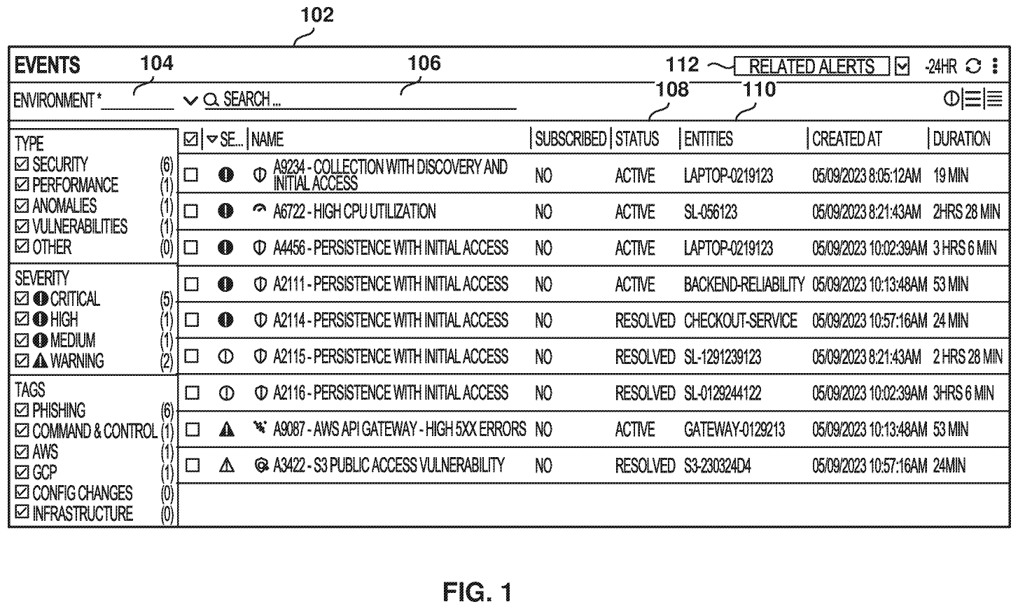

FIG. 1 is a user interface (UI) 102 showing a list of alerts 106, according to some example embodiments. The UI 102 includes a filter set 104, the list of alerts 106, a status 108, entities 110 associated with each alert, and other information. The status 108 indicates if the alert 106 is active or has been resolved, and the entities column 110 identifies the entity or entities associated with the alert.

The filter set 104 includes a list of filters that can be checked or unchecked to change the list of related alerts 106. In some example embodiments, the filter set 104 includes three categories of filters: type filters, severity filters, and tag filters.

The type filters are filters based on an area of interest in the related alerts, such as security, performance, anomalies, vulnerabilities, and other (everything else). The severity filters include categories on the assigned severity to the alert, such as critical, high, medium, and warning. The tag filters are based on tags associated with alerts or logs (e.g., metadata), such as phishing, command & control, Amazon Web Services (AWS), Google Cloud Platform (GCP), configuration changes, and infrastructure.

It is noted that the embodiments illustrated in FIG. 1 are examples and do not describe every possible embodiment. Other embodiments may utilize different filters, categories, layouts, columns, etc. The embodiments illustrated in FIG. 1 should therefore not be interpreted to be exclusive or limiting, but rather illustrative.

The present embodiments address the problem of managing and correlating disparate signals related to security. The problem involves the abundance of signals originating from various sources, making it challenging to establish their correlation. For instance, when confronted with a potential security threat, such as a phishing email or a virus download, it becomes difficult to ascertain the existence of similar threats or related signals. Furthermore, signals indicating anomalies in computer performance, such as high CPU or memory usage, further complicate the correlation process.

The disclosed embodiments aim to resolve this problem by providing a mechanism to identify pertinent signals associated with a given alert or event. By analyzing and correlating these signals, the embodiments enable users to determine the interrelationship between different signals and identify related threats or incidents. Consequently, the system offers a solution to the challenge of managing and correlating disparate security signals, thereby providing a more efficient and effective approach to security analysis.

The system enables correlation of information, to facilitate faster issue resolution with reduced errors, by providing custom filtering tools to set the parameters that determine the scope of the information captured, such as the size of the filter “dragnet,” e.g., how strict or loose to set the filters to include more or less results. This customization feature is particularly advantageous as it allows users to adjust the filtering scope to capture specific signals while filtering out irrelevant ones.

The system automatically identifies upstream and downstream events of interest and allows to group related signals together, providing a comprehensive understanding of the situation. By facilitating faster identification of related issues, the system enables bulk remediation and automated remediation.

For example, the system allows for the identification and selection of multiple infected laptops and enables their removal from the system and quarantine with a single click. This feature not only prevents further infection but also expedites the remediation process.

A sample scenario includes an analyst seeing a security alert which shows a file that is malicious, and this alert bears farther investigation and remediation. The analyst wants to determine how widespread the issue is and observes that there are related alerts on the same machine (e.g., Laptop-0219123), as well as other signals that indicate the same external internet protocol (IP) address and domain, which may indicate a wide-spread attack that goes beyond the single machine.

Other some sample scenarios for utilizing the filtering tool include:
Observing security and observability signals together so the analyst can correlate the information in the same case and solve issues faster, easier, and with fewer errors;
Find related signals (e.g., alerts, signals, log messages) to determine the scope of the problem automatically, find the rout cause, and remediate related signals together; and
Find solutions for entities of similar type using automation (playbooks) to streamline remediation faster and more efficiently.

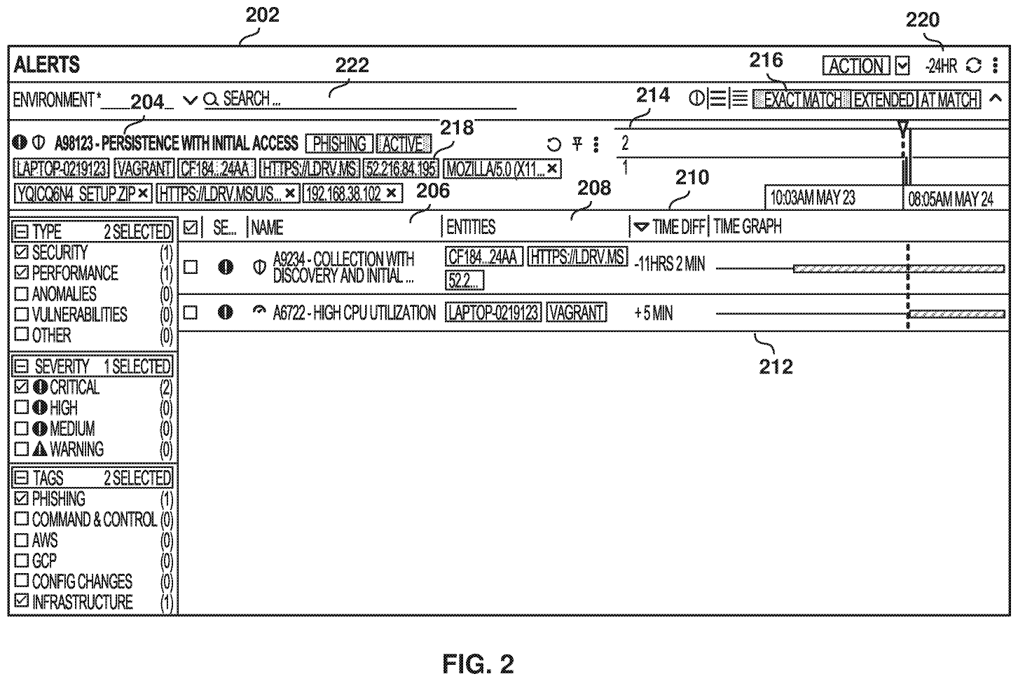

The analyst could investigate each alert separately, but the analyst can also select an alert and select the option related alerts 112 to see correlated information, as described below with reference to FIGS. 2-8. A related alert is an alert that shares temporal, spatial, or computational relationships with the alert under investigation (e.g., the alert selected by the user).

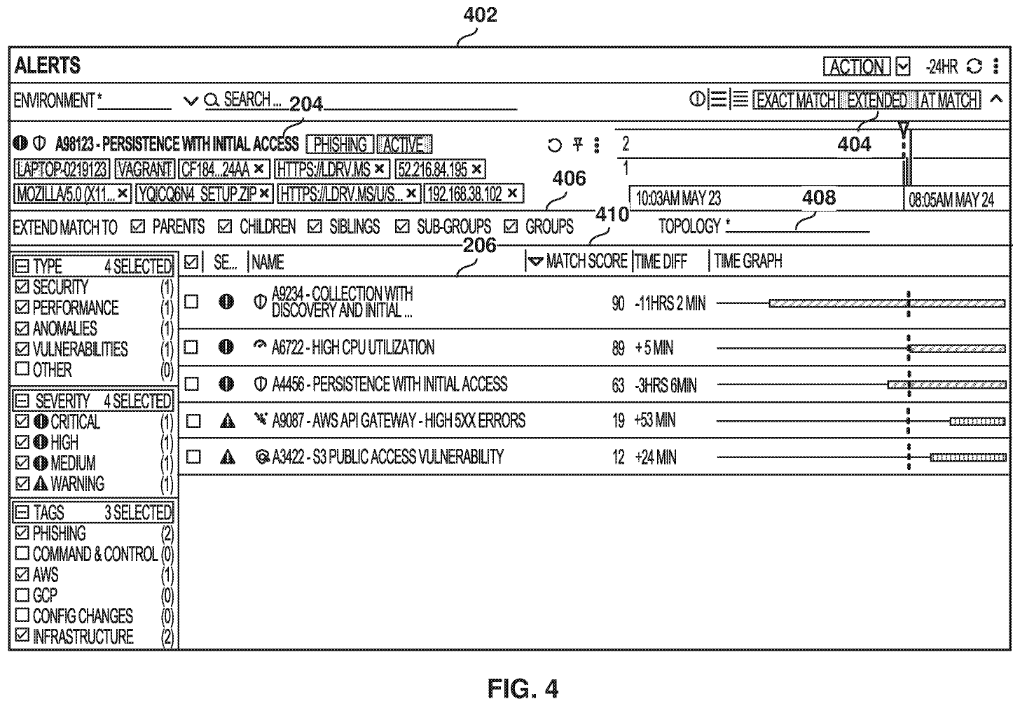

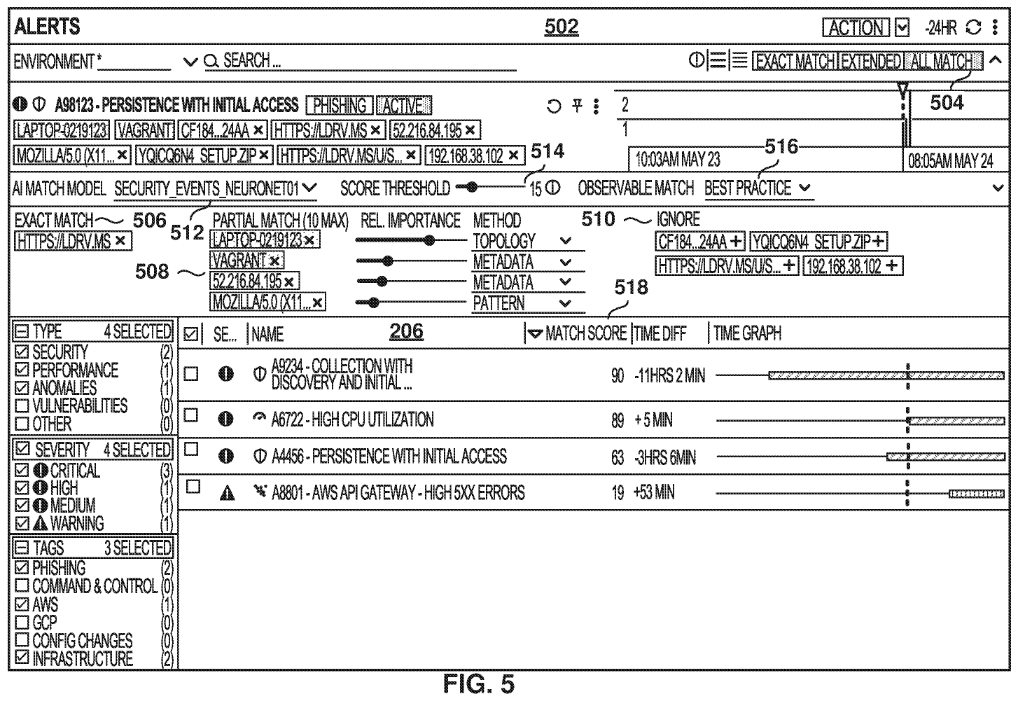

FIG. 2 is UI 202 showing a list of events associated with an alert, according to some example embodiments. The filtering tool presents a list of events when the extend-match option 216 is selected. Other options include the extended option and the AI option, described in more detail below with reference to FIGS. 4 and 5.

The UI 202 includes the alert 204 that was selected, related alerts 206 (e.g., alerts or events), entities 208 for each alert, a time difference 210, a time graph 212, a keyword search field 222, and an alert time graph 214. In the illustrated example, the alert 204 relates to a phishing attempt. The alert time graph 214 includes a bar graph showing when the alert 204 happened, the time graph 212 shows when the related alerts where active, and the time difference shows the time differences between the alert 204 and the related alerts 206.

The keyword search field 222 is for entering text to initiate a search based on input text, and the input text would be searched in any field associated with log data (e.g., log data received, augmented metadata).

The UI also includes a configurable time period 220 that frames the analysis, and in the illustrated example the value is 24 hours, so the related alerts 206 are alerts that are connected to each other and occur within a 24-hour time frame. The alert time graph 214 shows the time that the alert was triggered with a down arrow pointing to the vertical line at the trigger time (e.g., when a log was generated).

The user can see the results of comparing alerts, and in the illustrated example, see that the first of the related alerts 206 started before the alert 204 and the second of the related alerts 206 started at about the same time as the alert 204. In some example embodiments, the related alerts 206 are sorted based on creation time, with the alert that was triggered earlier being at the top of the list. The time difference 210 column shows the difference between the triggering of the alert 204 and the triggering of each of the related alerts 206.

The time difference 210 shows that the first alert was triggered 11 hours and 2 minutes before the alert 204, and the second alert was triggered 5 minutes after the alert 204. The time graph 212 shows that both related alerts 206 are still active. In some example embodiments, colors may be used for the lines in time graph 212 to indicate the progression of an event from a warning state to a major state, and subsequently to a critical state. The time graph 212 could also depict the resolution of an event, transitioning back to a minor state.

One advantage of the filtering tool is the ability to analyze multiple problems together by placing them in the same investigation and solving them in bulk. Further, the filtering tool is very versatile in handling various types of data, including alerts, signals, and log messages. These data can be analyzed and compared at different levels of investigation, ranging from high-level alerts that aggregate multiple logs or metrics, to individual log entries. The user interface remains consistent across these different levels, facilitating ease of use and flexibility in the investigation process.

The UI 202 further includes a list of entities 218 presented as selectable boxes, and the entities selected will cause related alerts to be presented while the entities not selected will be ignored. In the illustrated examples, some entities 218 are selected (e.g., Laptop-0219123) and others are not selected (e.g., Mozilla/5.0 . . . ). The user may quickly select or deselect the entities 218 and the results will be filtered accordingly. Further, the filter set 104 shows that some filters are selected and others are not. Again, the user may quickly select or deselect any of the filters by selecting or deselecting the corresponding check box. In some embodiments, the entities used as filters are combined using a logical OR operator, that is, the results will include related alerts that include at least one of the entities selected. In other embodiments, the filters may be combined using the logical AND operator or using any other combination of logical operators (e.g., OR, AND, NOT, XOR, etc.).

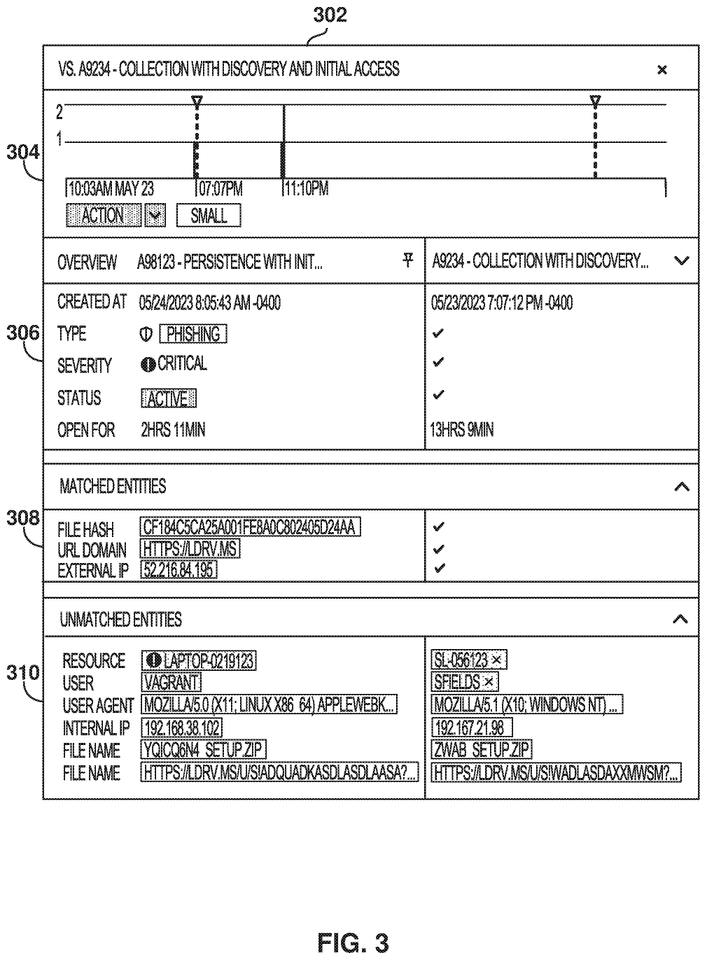

FIG. 3 is a window 302 of the UI 202 showing a detailed comparison of events of interest, according to some example embodiments. A user may select one of the related alerts 206 and the window 302 will be overlayed on the UI with information comparing the alert 204 with the selected alert. In the illustrated example, the first alert A9234 has been selected. This provides a quick comparison for the data of the two alerts.

The window 302 includes a time diagram 304 comparing the two alerts, e.g., showing when the alerts were triggered. Below the time diagram 304, a table with three columns is shown, with the first column for the parameter being compared, the second column for the data of the alert 204, and the third column for the data of the selected alert. Further, the table is divided in three sections: overview section 306, matched entities 308, and unmatched entities 310.

The overview section 306 provides information about the alert, such as when the alert was created, type of alert, severity, status, and the amount of time that the alert has been opened. The matched entities 308 section identifies the entities that matched both alerts. Although the example embodiment shows the matched entities in one column, other embodiments may show the matched entities in both columns since both alerts were related to those entities. Further, the unmatched entities 310 shows a list of entities that were not matched, such as user, user agent, internal IP address, filename, etc.

FIG. 4 is a UI 402 showing the extended option to present additional events of interest, according to some example embodiments. In the extended option 404, the list of related alerts 206 is expanded to include additional alerts based on expansion parameters 406. For example, a user can be associated with groups (e.g., Unix-designers group, staff group, remote workers group). Thus, the related alerts 206 may be expanded to include other events associated with members of the groups selected. In the illustrated example, the groups include parents in a hierarchy, children, siblings, sub-groups, and the audit groups. Each of the groups may be selected or deselected, and the related alerts 206 will be expanded or contracted to cover the selected groups. The match score 410 shows how related the related alert 206 is to the alert 204, where the higher the score, the more related the alerts are.

For example, the user may want to inspect network relationships between devices, such as which devices are communicating with the laptop. Often, a firewall communicates with the laptop before the laptop communicates to the internet via the firewall. In this case, the firewall is the parent, and the laptop is the child. Or the laptop may communicate to a printer, and the printer will be child of the laptop. Also, the laptop may have siblings on the network, such as other laptops, that the laptop communicates with (e.g., to exchange files).

In the illustrated example, all the groups have been selected in the expansion parameters 406, and the number of related alerts 206 has increased with additional related alerts. The topology filter 408 may also be selected to include a certain type of topology, such as network, storage, account, firewall, Kubernetes, etc. If a topology is selected, then the additional entries will be selected based on the selected topology. For example, if network is selected as the topology, only alerts related to the same network of the alert under this section will be selected.

FIG. 5 is a UI 502 showing the AI option 504 to show events of interest, according to some example embodiments. The UI 502 includes several AI-related options, such as the AI match model 512, a score threshold 514, observable match 516, exact-match entities 506, partial match entities 508, and ignored entities 510 (e.g., entities excluded from the results). Users may simply move (e.g., drag with a mouse pointer) entities from one section to another to quickly change the filtering. For example, a filter may be deselected and then it will be moved to the ignored entities 510. In some embodiments, the filters are combined using logical OR operations, but other embodiments may include other options to combine the filters using different logical operations.

The AI option 504 provides results based on perfect matches and partial matches, where a partial match is a match that is related to the original alert, but it is not a perfect match. The partial matches are associated with a match score, where the closer the match is, the higher the match score will be. The match score may be based on multiple factors, such as similarity on the type of alert, similarity on the devices affected (e.g., laptops, mobile devices, network equipment), devices on the same network, devices on the same physical location, etc.

The objective of the AI option 504 is to strike a balance between providing an adequate number of options for the user to consider and avoiding an overwhelming number of choices. For example, if the score threshold 514 is too low, then the results may be in the hundreds or thousands, and if the score threshold 514 is too high, the results will be the same as with the exact-match option. The balance is achieved by identifying a subset of properties that are likely to be of interest to the user, based on the specific alert type and the relative importance of different criteria.

The score threshold 514 is configurable by the user, such as by changing the score in a sliding field or entering a specific score threshold. In the illustrated example, the score threshold 514 is set to 15 on a score scale from 1 to 100, but other embodiments may use other scales.

The partial match entities 508 provides a list of the entities that have been matched, and each entity is assigned a relative importance, which is a score within a range (e.g., from 1 to 10, from 1 to 100). The user may change the relative importance based on their goals, e.g., do I want to see what happened with other laptops or do I rather focus on devices in the same network?

In some example embodiments, the system assigns initial scores for the relative importance and the user may change the values. For example, the system may focus on the type of alert (e.g., a phishing attack) and assign higher priorities to entities and alerts related to phishing attacks.

Further, for each partial match entity 508, there is a method to calculate the matching score, and the method can be based on the topology, metadata in the logs, pattern of attack, etc. For example, for the topology method, the filtering tool will create a score based on the hierarchy, e.g., show me parents, siblings, children. For the metadata method, the filtering tool will calculate the score based on the metadata of the logs associated with the alert, e.g., IP address, device name.

Thus, the AI option aims to present users with a curated list of options that align with their preferences, without requiring significant manual effort in filtering through a large number of choices. By considering the specific alert type and the relative importance of different criteria, the filtering tool provides users with a manageable number of relevant options that meet their specific needs and preferences.

In the illustrated example, the AI option provides two additional related alerts to examine. Each entry has a match score 518 and the list of related alerts 206 is ordered in descending match score, which is helpful when the number of related alerts is large (e.g., more than ten, more than 50). In a way, by sorting the results by the match score 518, an additional level of filtering is provided, sometimes called filtering by sorting, because the user may not pay attention to the items at the end of the list and focus on the more relevant items at the top of the list. In some example embodiments, the match score 518 is calculated using a formula, e.g., a weighted sum of the relative importance of each factor applied to the related alert, but other equations may be used.

The AI match model 512 determines which AI model is used for the AI filtering. The system may develop different models that may be better suited for different situations and make those models available for filtering. In the illustrated example, the AI model selected is related to security and has the name security_events_neuronet01 (which uses a neural network).

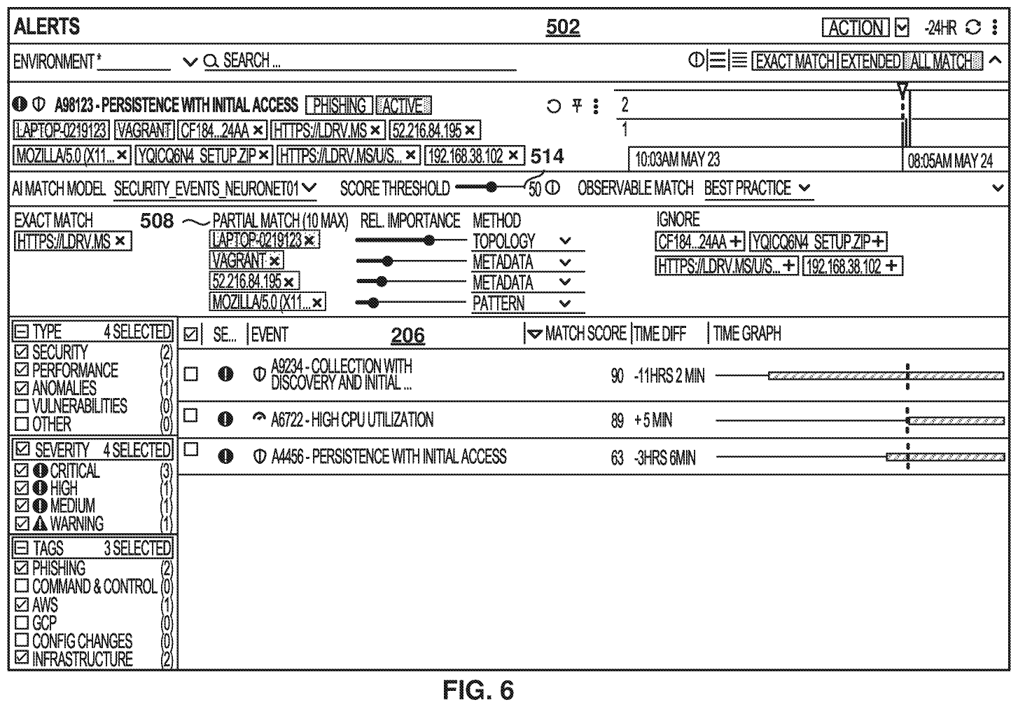

FIG. 6 is the UI 502 after changing the score threshold 514, according to some example embodiments. In the illustrated example, the user has changed the score threshold 514 to a value of 50. As a result, the last of the related alerts 206 is eliminated since this entry had a match score of 19.

In the case where the user may have a large list of related alerts 206 (e.g., fifty alerts or more), changing the score threshold 514 is a quick way to eliminate from view the lower scores and reduce the list.

Further, the user may also change the relative importance of the partial match entities 508, which will cause the match scores 518 to change, which may cause a new resorting of the related alerts 206.

For example, if the user changes the relative importance of one of the partial match entities 508, the list of related alerts 206 may change by adding new items to the list and taking out items from the list that now have a score lower than the score threshold 514.

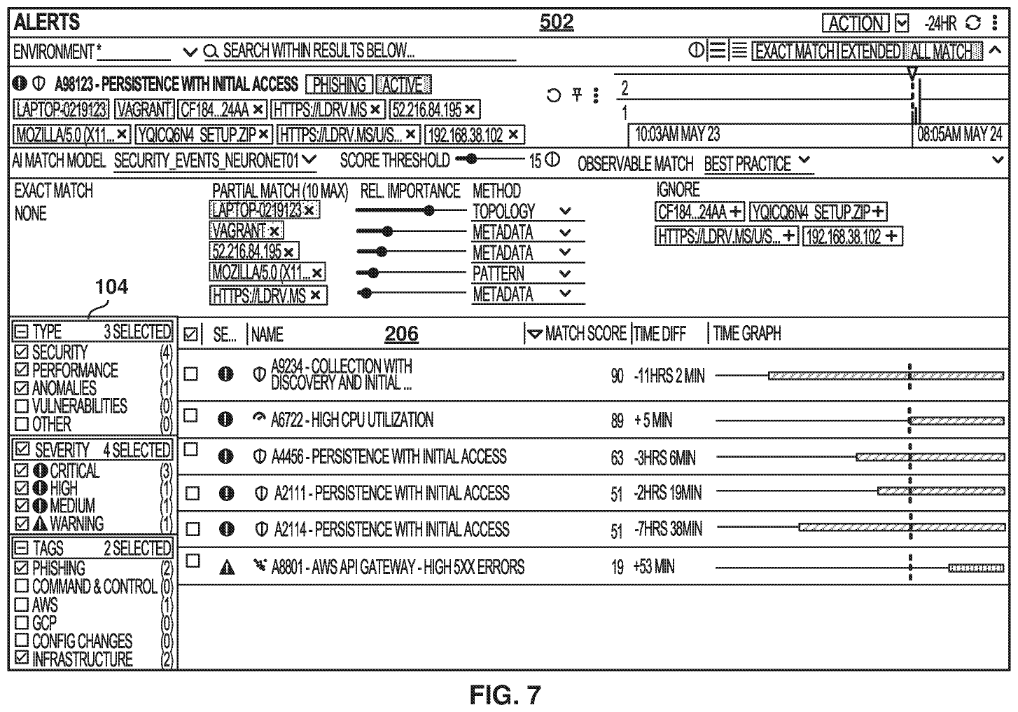

FIG. 7 is the UI 502 after changing some of the filters, according to some example embodiments. In the illustrated example, the user has decided to see additional entries, so the user has changed the filter set 104 by adding the filters “Anomalies” and alerts with a severity of “Warning.”

The result is that the number of related alerts 206 has increased to six because of the addition of anomalies and warnings. This shows how the filtering tools provide multiple mechanisms for filtering data of interest to the user to investigate different aspects, with filters on multiple dimensions, and with the ability to get quick results by easily adjusting the filtering methods.

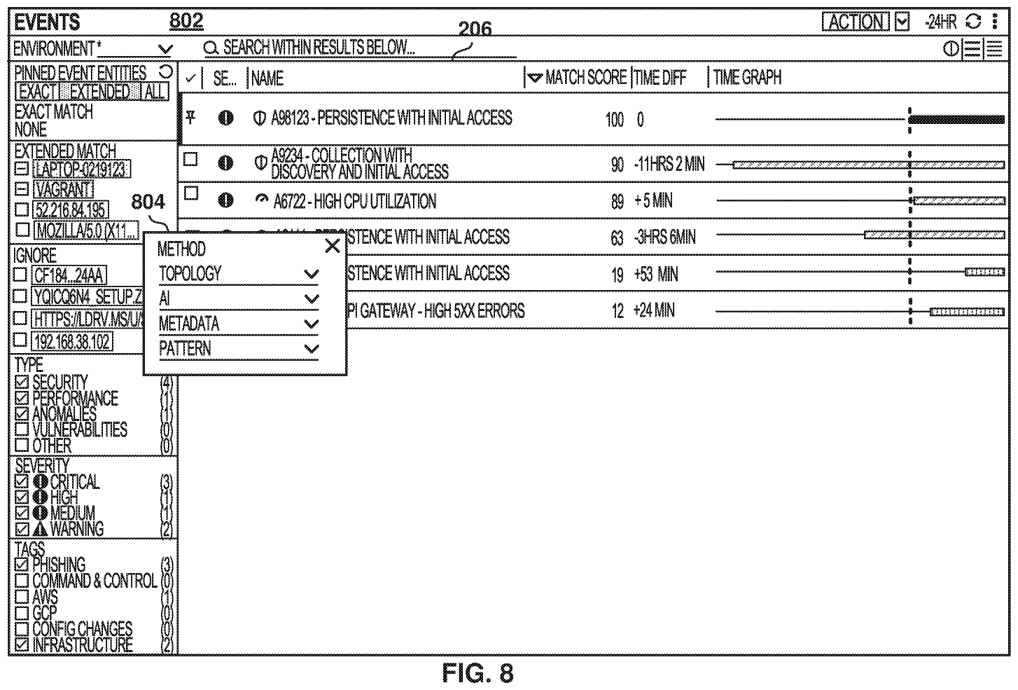

FIG. 8 is a UI 802 showing a different layout for the AI-match option presenting events, according to some example embodiments. The UI layouts showing in FIGS. 1-7 are meant to be illustrative and other types of layouts may be used to present the different filter options and list of results.

In the example of FIG. 8, the UI 802 shows the option to change the method for calculating the relative importance as a pop-up window 804, where the user can click on a related alert and then change the method in window 804. After the method is changed, the window 804 is eliminated.

The different filters in the UI 802 are provided on the left column, where in previous layouts only the filter set 104 was presented, now the other filters are added, such as exact match, partial match, etc.

Since this layout presents the filters on the left side of the UI 802, there is more space to present information for the related alerts 206 and improve the readability for the user (e.g., the time graphs can be expanded).

Additionally, the order of the filters and attributes may be changed by the user (e.g., click and drag on the UI 802) to move the filters to a different location on the UI.

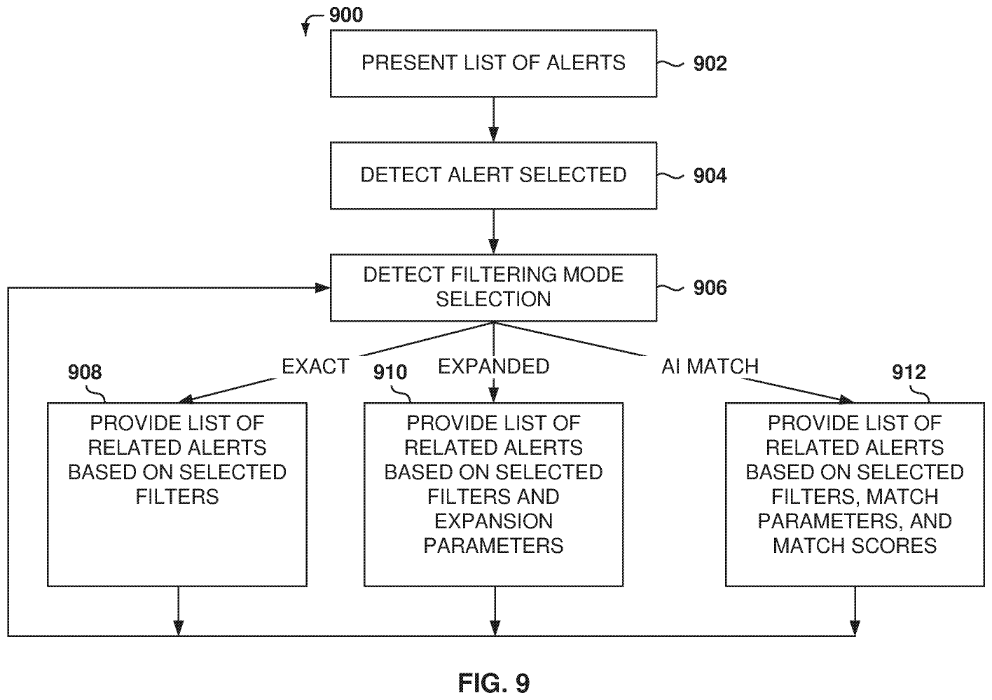

FIG. 9 is a flowchart of a method for providing the UI with multiple types of filters, according to some example embodiments. While the various operations in this flowchart are presented and described sequentially, one of ordinary skill will appreciate that some or all of the operations may be executed in a different order, combined, omitted, or executed in parallel.

Operation 902 is for presenting a list of alerts. From operation 902, the method 900 flows to operation 904 where an alert is selected.

From operation 904, the method 900 flows to operation 906 where the filtering mode is selected. In some example embodiments, the filtering modes include exact, expanded, and AI match.

If the exact mode is selected, the method 900 flows to operation 908, where a list of related alerts is presented based on the selected filters, as described above with reference to FIG. 2.

If the expanded mode is selected, the method 900 flows to operation 910 to provide a list of related alerts based on the selected filters and the expansion parameters, as described above with reference to FIG. 4.

If the AI-match mode is selected, the method 900 flows to operation 912 to provide a list of related alerts based on the selected filters, match parameters, and match scores, as described above with reference to FIG. 5. The user may change filtering modes and then the corresponding UI will be presented on the UI.

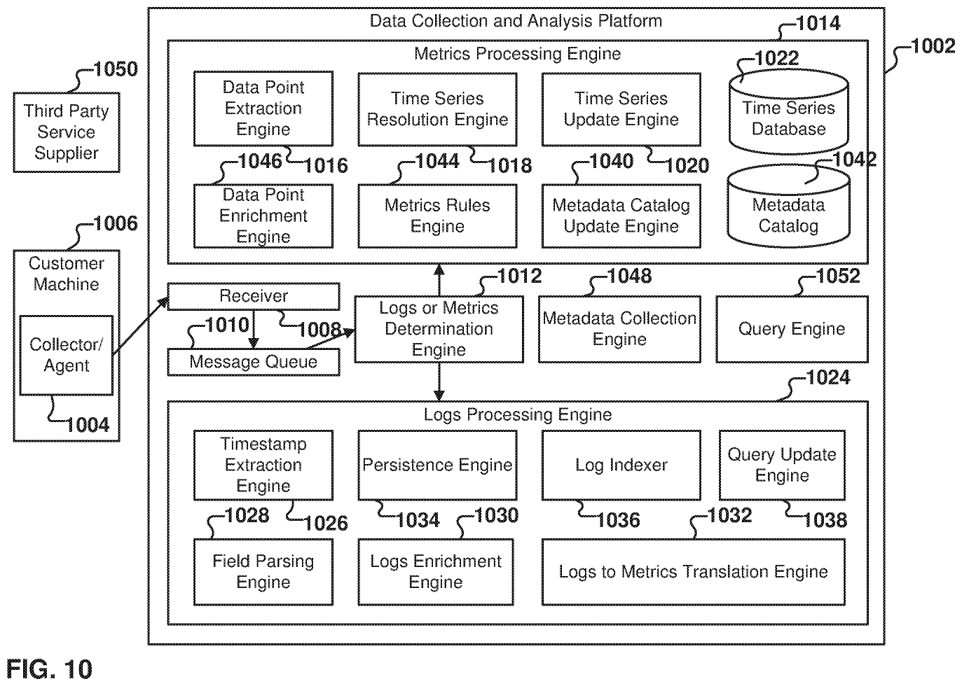

FIG. 10 illustrates an embodiment of an environment in which machine data collection and analysis is performed. In this example, data collection and analysis platform 1002 (also referred to herein as the “platform” or the “system”) is configured to ingest and analyze machine data (e.g., log messages and metrics) collected from customers (e.g., entities utilizing the services provided by the data collection and analysis platform 1002). For example, collectors (e.g., collector/agent 1004 installed on machine 1006 of a customer) send log messages to the platform over a network (such as the Internet, a local network, or any other type of network, as appropriate); customers may also send logs directly to an endpoint such as a common HTTPS endpoint. Collectors can also send metrics, and likewise, metrics can be sent in common formats to the HTTPS endpoint directly. In some embodiments, metrics rules engine 1044 is a processing stage (that may be user guided) that can change existing metadata or synthesize new metadata for each incoming data point.

As used herein, log messages and metrics are but two examples of machine data that may be ingested and analyzed by the data collection and analysis platform 1002 using the techniques described herein. Collector/Agent 1004 may also be configured to interrogate machine 1006 directly to gather various host metrics such as CPU (central processing unit) usage, memory utilization, etc.

Machine data, such as log data and metrics, are received by receiver 1008, which, in one example, is implemented as a service receiver cluster. Logs are accumulated by each receiver into bigger batches before being sent to message queue 1010. In some embodiments, the same batching mechanism applies to incoming metrics data points as well.

The batches of logs and metrics data points are sent from the message queue to logs or metrics determination engine 1012. Logs or metrics determination engine 1012 is configured to read batches of items from the message queue and determine whether the next batch of items read from the message queue is a batch of metrics data points or whether the next batch of items read from the message queue is a batch of log messages. For example, the determination of what machine data is a log message or a metrics data point is based on the format and metadata of the machine data that is received.

In some embodiments, a metadata index (stored, for example, as metadata catalog 1042 of platform 1002) is also updated to allow flexible discovery of time series based on their metadata. In some embodiments, the metadata index is a persistent data structure that maps metadata values for keys to a set of time series identified by that value of the metadata key.

For a collector, there may be several types of sources from which raw machine data is collected. The type of source may be used to determine whether the machine data is logs or metrics. Depending on whether a batch of machine data includes log messages or metrics data points, the batch of machine data will be sent to one of two specialized backends, metrics processing engine 1014 and logs processing engine 1024, which are optimized for processing log messages and metrics data points, respectively.

When the batch of items read from the message queue is a batch of metrics data points, the batch of items is passed downstream to metrics processing engine 1014. Metrics processing engine 1014 is configured to process metrics data points, including extracting and generating the data points from the received batch of metrics data points (e.g., using data point extraction engine 1016). Time series resolution engine 1018 is configured to resolve the time series for each data point given data point metadata (e.g., metric name, identifying dimensions). Time series update engine 1020 is configured to add the data points to the time series (stored in this example in time series database 1022) in a persistent fashion.

If logs or metrics determination engine 1012 determines that the batch of items read from the message queue is a batch of log messages, the batch of log messages is passed to logs processing engine 1024. Logs processing engine 1024 is configured to apply log-specific processing, including timestamp extraction (e.g., using timestamp extraction engine 1026) and field parsing using extraction rules (e.g., using field parsing engine 1028). Other examples of processing include further augmentation (e.g., using logs enrichment engine 1030).

The ingested log messages and metrics data points may be directed to respective log and metrics processing backends that are optimized for processing the respective types of data. However, there are some cases in which information that arrived in the form of a log message would be better processed by the metrics backend than the logs backend. One example of such information is telemetry data, which includes, for example, measurement data that might be recorded by an instrumentation service running on a device. In some embodiments, telemetry data includes a timestamp and a value. The telemetry data represents a process in a system. The value relates to a numerical property of the process in question. For example, a smart thermostat in a house has a temperature sensor that measures the temperature in a room on a periodic basis (e.g., every second). The temperature measurement process therefore creates a timestamp-value pair every second, representing the measured temperature of that second.

Telemetry may be efficiently stored in, and queried-from, a metrics time series store (e.g., using metrics backend 1014) than by abusing a generic log message store. By doing so, customers utilizing the data collection and analysis platform 1002 can collect host metrics such as CPU usage directly using, for example, a metrics collector. In this case, the collected telemetry is directly fed into the optimized metrics time series store (e.g., provided by metrics processing engine 1014). The system can also at the collector level interpret a protocol, such as the common Graphite protocol, and send it directly to the metrics time series storage backend.

As another example, consider a security context, in which syslog messages may come in the form of CSV (comma separated values). However, storing such CSV values as a log would be inefficient, and it should be stored as a time series to better query that information. In some example embodiments, although metric data may be received in the form of a CSV text log, the structure of such log messages is automatically detected, and the values from the text of the log (e.g., the numbers between the commas) are stored in a data structure such as columns of a table, which better allows for operations such as aggregations of table values, or other operations applicable to metrics that may not be relevant to log text.

The logs-to-metrics translation engine 1032 is configured to translate log messages that include telemetry data into metrics data points. In some embodiments, translation engine 1032 is implemented as a service. In some embodiments, upon performing logs to metrics translation, if any of the matched logs-to-metrics rules indicates that the log message (from which the data point was derived) should be dropped, the log message is removed. Otherwise, the logs processing engine is configured to continue to batch log messages into larger batches to persist them (e.g., using persistence engine 1034) by sending them to an entity such as Amazon S3 for persistence.

The batched log messages are also sent to log indexer 1036 (implemented, for example, as an indexing cluster) for full-text indexing and query update engine 1038 (implemented, for example, as a continuous query cluster) for evaluation to update streaming queries.

In some embodiments, once the data points are created in memory, they are committed to persistent storage such that a user can then query the information. In some embodiments, the process of storing data points includes two distinct parts and one asynchronous process. First, based on identifying metadata, the correct time series is identified, and the data point is added to that time series. In some embodiments, the time series identification is performed by time series resolution engine 1018 of platform 1002. Secondly, a metadata index is updated in order for users to more easily find time series based on metadata. In some embodiments, the updating of the metadata index (also referred to herein as a “metadata catalog”) is performed by metadata catalog update engine 1040.

Thus, the data collection and analysis platform 1002, using the various backends described herein, can handle any received machine data in the most native way, regardless of the semantics of the data, where machine data may be represented, stored, and presented back for analysis in the most efficient way. Further, a data collection and analysis system, such as the data collection and analysis platform 1002, has the capability of processing both logs and time series metrics, provides the ability to query both types of data (e.g., using query engine 1052) and creates displays that combine information from both types of data visually.

The log messages may be clustered by key schema. Structured log data is received (it may have been received directly in structured form, or extracted from a hybrid log, as described above). An appropriate parser consumes the log, and a structured map of keys to values is output. All the keys in the particular set for the log are captured. In some embodiments, the values are disregarded. Thus, for the one message, only the keys have been parsed out. That set of keys then goes into a schema which may be used to generate a signature and used to group the log messages. That is, the signature for logs in a cluster may be computed based on the unique keys the group of logs in the cluster contains. The log is then matched to a cluster based on the signature identifier. In some embodiments, the signature identifier is a hash of the captured keys. In some embodiments, each cluster that is outputted corresponds to a unique combination of keys. In some embodiments, when determining which cluster to include a log in, the matching of keys is exact, where the key schemas for two logs are either exactly the same or different.

In some embodiments, data point enrichment engine 1046 and logs enrichment engine 1030 are configured to communicate with metadata collection engine 1048 to obtain, from a remote entity such as third-party service supplier 1050, additional data to enrich metrics data points and log messages, respectively.

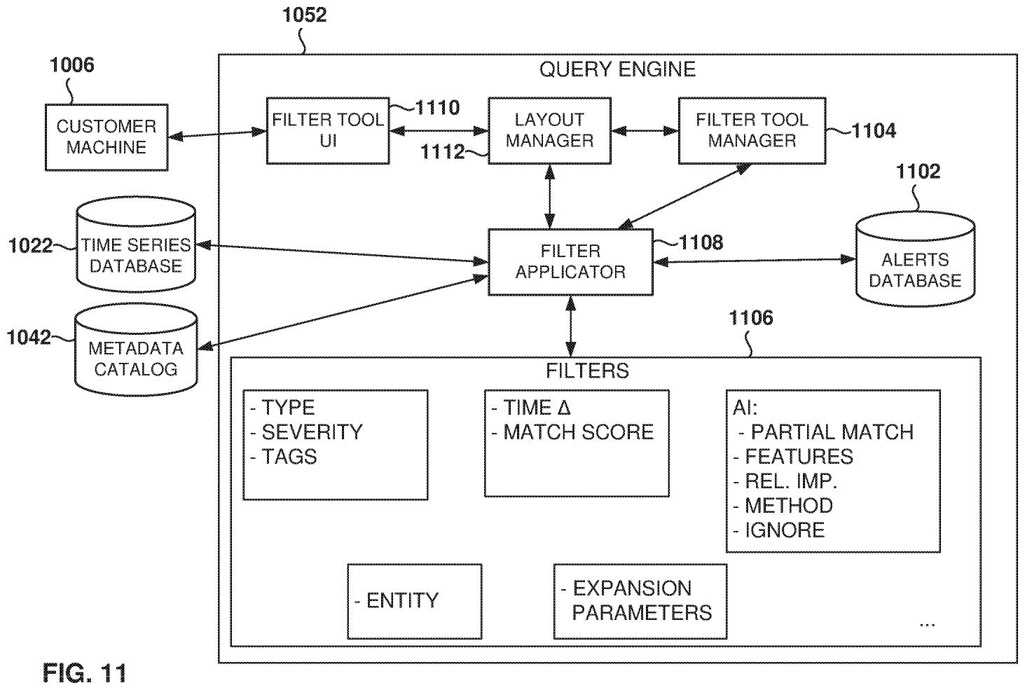

FIG. 11 shows architectural details of the query engine 1052, according to some example embodiments. The query engine 1052 includes a filter tool UI 1110, a layout manager 1112, a filter tool manager 1104, a filter applicator 1108, an alerts database 1102 (including the alerts in the system, active and otherwise), and filters 1106.

The filter tool manager 1104 coordinates the operations of the different modules in the query engine 1052 and may also communicate with other components of the data collection and analysis platform 1002.

The filter tool UI 1110 provides UI that is presented on the customer machine 1006. The layout manager 1112 prepares the layout for the filter tool UI 1110.

The filter applicator 1108 accesses data in the system (e.g., the time series database 1022, the metadata catalog 1042, and the alerts database 1102) and applies the active filters 1106 to generate data for presentation, and the data is then prepared for presentation by the layout manager 1112.

It is noted that the embodiments illustrated in FIG. 11 are examples and do not describe every possible embodiment. Other embodiments may utilize different modules, combine functionality of the different modules, provide a distributed environment, used other types of filters, etc. The embodiments illustrated in FIG. 11 should therefore not be interpreted to be exclusive or limiting, but rather illustrative.

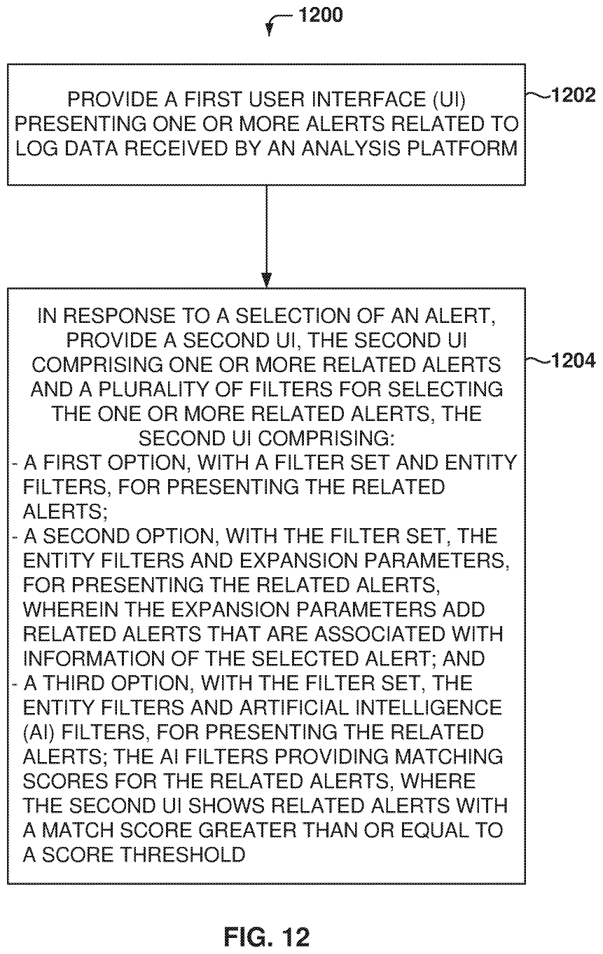

FIG. 12 is a flowchart of a method for providing a versatile tool for filtering signals to assist in problem resolution, according to some example embodiments. Operation 1202 is for providing a first UI presenting one or more alerts related to log data received by an analysis platform.

From operation 1202, the method 1200 flows to operation 1204 to, in response to a selection of an alert, providing a second UI. The second UI comprises one or more related alerts and a plurality of filters for selecting the one or more related alerts.

The second UI comprises a first option, with a filter set and entity filters, for presenting the related alerts; a second option, with the filter set, the entity filters and expansion parameters, for presenting the related alerts, wherein the expansion parameters add related alerts that are associated with information of the selected alert; and a third option, with the filter set, the entity filters and AI filters, for presenting the related alerts; the AI filters providing matching scores for the related alerts, wherein the second UI shows related alerts with a match score greater than or equal to a score threshold.

In view of the disclosure above, various examples are set forth below. It should be noted that one or more features of an example, taken in isolation or combination, should be considered within the disclosure of this application.

In one example, the method 1200 further comprises, in response to selecting one related alert in the second UI, presenting a comparison of information from the selected related alert and the selected alert.

In one example, the method 1200 further comprises calculating a matching score for each of the related alerts in the third option of the second UI, the matching score based on one or more partial entity matches and respective importance parameter values of the one or more partial entity matches.

In one example, the method 1200 further comprises providing, in the third option of the second UI, an option to change the score threshold; and updating the one or more related alerts presented in the second UI after detecting a change in the score threshold.

In one example, the third option of the second UI further includes a filter to select entities that are an exact match and a filter to ignore entities.

In one example, the filter set includes a list of filters that can be checked or unchecked to change the related alerts presented, and the filter set 104 includes three categories of filters: type filters, severity filters, and tag filters.

In one example, the second UI further comprises a time graph for each related alert, and an alert time graph for the selected alert.

In one example, the second UI further comprises a time different for each related alert showing a difference between triggering of the selected alert and the related alert.

In one example, the second option of the second UI further comprises a topology filter to filter related alerts based on topology.

In one example, the entity filters may be selected and deselected with a click of a mouse pointer.

Another general aspect is for a system that includes a memory comprising instructions and one or more computer processors. The instructions, when executed by the one or more computer processors, cause the one or more computer processors to perform operations comprising: providing a first user interface (UI) presenting one or more alerts related to log data received by an analysis platform; and in response to a selection of an alert, providing a second UI, the second UI comprising one or more related alerts and a plurality of filters for selecting the one or more related alerts, the second UI comprising: a first option, with a filter set and entity filters, for presenting the related alerts; a second option, with the filter set, the entity filters and expansion parameters, for presenting the related alerts, wherein the expansion parameters add related alerts that are associated with information of the selected alert; and a third option, with the filter set, the entity filters and artificial intelligence (AI) filters, for presenting the related alerts; the AI filters providing matching scores for the related alerts, wherein the second UI shows related alerts with a match score greater than or equal to a score threshold.

In yet another general aspect, a non-transitory machine-readable storage medium (e.g., a non-transitory storage medium) includes instructions that, when executed by a machine, cause the machine to perform operations comprising: providing a first user interface (UI) presenting one or more alerts related to log data received by an analysis platform; and in response to a selection of an alert, providing a second UI, the second UI comprising one or more related alerts and a plurality of filters for selecting the one or more related alerts, the second UI comprising: a first option, with a filter set and entity filters, for presenting the related alerts; a second option, with the filter set, the entity filters and expansion parameters, for presenting the related alerts, wherein the expansion parameters add related alerts that are associated with information of the selected alert; and a third option, with the filter set, the entity filters and artificial intelligence (AI) filters, for presenting the related alerts; the AI filters providing matching scores for the related alerts, wherein the second UI shows related alerts with a match score greater than or equal to a score threshold.

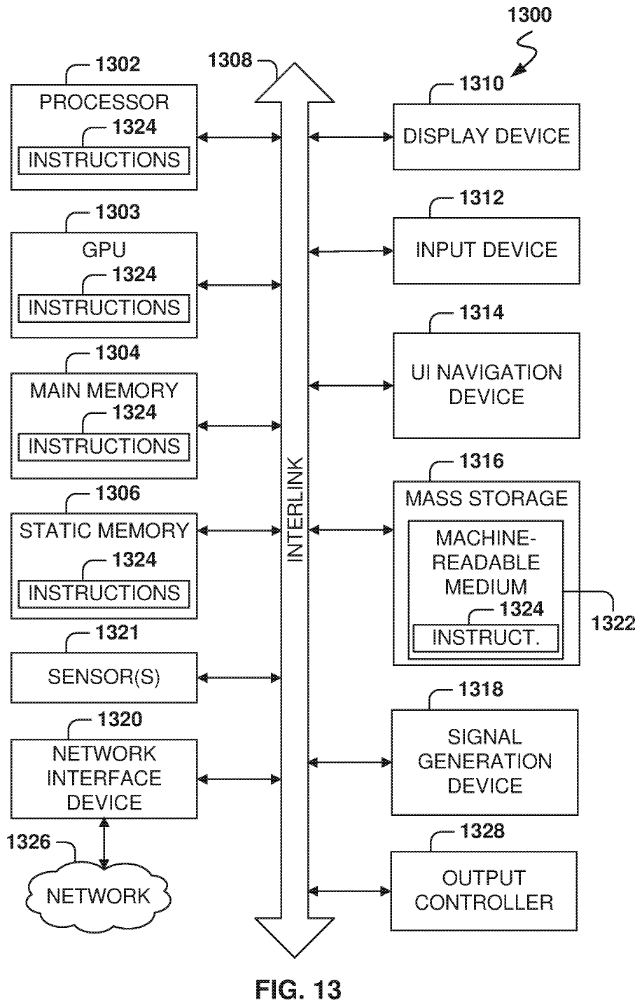

FIG. 13 is a block diagram illustrating an example of a machine 1300 upon or by which one or more example process embodiments described herein may be implemented or controlled. In alternative embodiments, the machine 1300 may operate as a standalone device or may be connected (e.g., networked) to other machines. In a networked deployment, the machine 1300 may operate in the capacity of a server machine, a client machine, or both in server-client network environments. In an example, the machine 1300 may act as a peer machine in a peer-to-peer (P2P) (or other distributed) network environment. Further, while only a single machine 1300 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, various components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine 1300 (e.g., computer system) may include a hardware processor 1302 (e.g., a central processing unit (CPU), a hardware processor core, or any combination thereof), a graphics processing unit (GPU 1303), a main memory 1304, and a static memory 1306, some or all of which may communicate with each other via an interlink 1308 (e.g., bus). The machine 1300 may further include a display device 1310, an alphanumeric input device 1312 (e.g., a keyboard), and a user interface (UI) navigation device 1314 (e.g., a mouse). In an example, the display device 1310, alphanumeric input device 1312, and UI navigation device 1314 may be a touch screen display. The machine 1300 may additionally include a mass storage device 1316 (e.g., drive unit), a signal generation device 1318 (e.g., a speaker), a network interface device 1320, and one or more sensors 1321, such as a Global Positioning System (GPS) sensor, compass, accelerometer, or another sensor. The machine 1300 may include an output controller 1328, such as a serial (e.g., universal serial bus (USB)), parallel, or other wired or wireless (e.g., infrared (IR), near field communication (NFC)) connection to communicate with or control one or more peripheral devices (e.g., a printer, card reader).

The mass storage device 1316 may include a machine-readable medium 1322 on which is stored one or more sets of data structures or instructions 1324 (e.g., software) embodying or utilized by any one or more of the techniques or functions described herein. The instructions 1324 may also reside, completely or at least partially, within the main memory 1304, within the static memory 1306, within the hardware processor 1302, or within the GPU 1303 during execution thereof by the machine 1300. In an example, one or any combination of the hardware processor 1302, the GPU 1303, the main memory 1304, the static memory 1306, or the mass storage device 1316 may constitute machine-readable media.

While the machine-readable medium 1322 is illustrated as a single medium, the term “machine-readable medium” may include a single medium, or multiple media, (e.g., a centralized or distributed database, and/or associated caches and servers) configured to store the one or more instructions 1324.

The term “machine-readable medium” may include any medium that is capable of storing, encoding, or carrying instructions 1324 for execution by the machine 1300 and that cause the machine 1300 to perform any one or more of the techniques of the present disclosure, or that is capable of storing, encoding, or carrying data structures used by or associated with such instructions 1324. Non-limiting machine-readable medium examples may include solid-state memories, and optical and magnetic media. In an example, a massed machine-readable medium comprises a machine-readable medium 1322 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1324 may be transmitted or received over a communications network 1326 using a transmission medium via the network interface device 1320.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
providing a first user interface (UI) presenting one or more alerts related to log data received by an analysis platform; and
in response to a selection of an alert, providing a second UI, the second UI comprising one or more related alerts and a plurality of filters for selecting the one or more related alerts, the second UI comprising:
a first option, with a filter set and entity filters, for presenting the related alerts;
a second option, with the filter set, the entity filters and expansion parameters, for presenting the related alerts, wherein the expansion parameters add related alerts that are associated with information of the selected alert; and
a third option, with the filter set, the entity filters and artificial intelligence (AI) filters, for presenting the related alerts;
the AI filters providing matching scores for the related alerts, wherein the second UI shows related alerts with a match score greater than or equal to a score threshold.

2. The method as recited in claim 1, further comprising:
in response to selecting one related alert in the second UI, presenting a comparison of information from the selected related alert and the selected alert.

3. The method as recited in claim 1, further comprising:
calculating a matching score for each of the related alerts in the third option of the second UI, the matching score based on one or more partial entity matches and respective importance parameter values of the one or more partial entity matches.

4. The method as recited in claim 1, further comprising:
providing, in the third option of the second UI, an option to change the score threshold; and
updating the one or more related alerts presented in the second UI after detecting a change in the score threshold.

5. The method as recited in claim 1, wherein the third option of the second UI further includes a filter to select entities that are an exact match and a filter to ignore entities.

6. The method as recited in claim 1, wherein the filter set includes a list of filters that can be checked or unchecked to change the related alerts presented, and the filter set 104 includes three categories of filters: type filters, severity filters, and tag filters.

7. The method as recited in claim 1, wherein the second UI further comprises a time graph for each related alert, and an alert time graph for the selected alert.

8. The method as recited in claim 1, wherein the second UI further comprises a time different for each related alert showing a difference between triggering of the selected alert and the related alert.

9. The method as recited in claim 1, wherein the second option of the second UI further comprises a topology filter to filter related alerts based on topology.

10. The method as recited in claim 1, wherein the entity filters may be selected and deselected with a click of a mouse pointer.

11. A system comprising:
a memory comprising instructions; and
one or more computer processors, wherein the instructions, when executed by the one or more computer processors, cause the system to perform operations comprising:
providing a first user interface (UI) presenting one or more alerts related to log data received by an analysis platform; and
in response to a selection of an alert, providing a second UI, the second UI comprising one or more related alerts and a plurality of filters for selecting the one or more related alerts, the second UI comprising:
a first option, with a filter set and entity filters, for presenting the related alerts;
a second option, with the filter set, the entity filters and expansion parameters, for presenting the related alerts, wherein the expansion parameters add related alerts that are associated with information of the selected alert; and
a third option, with the filter set, the entity filters and artificial intelligence (AI) filters, for presenting the related alerts;
the AI filters providing matching scores for the related alerts, wherein the second UI shows related alerts with a match score greater than or equal to a score threshold.

12. The system as recited in claim 11, wherein the instructions further cause the one or more computer processors to perform operations comprising:
in response to selecting one related alert in the second UI, presenting a comparison of information from the selected related alert and the selected alert.

13. The system as recited in claim 11, wherein the instructions further cause the one or more computer processors to perform operations comprising:
calculating a matching score for each of the related alerts in the third option of the second UI, the matching score based on one or more partial entity matches and respective importance parameter values of the one or more partial entity matches.

14. The system as recited in claim 11, wherein the instructions further cause the one or more computer processors to perform operations comprising:
providing, in the third option of the second UI, an option to change the score threshold; and
updating the one or more related alerts presented in the second UI after detecting a change in the score threshold.

15. The system as recited in claim 11, wherein the third option of the second UI further includes a filter to select entities that are an exact match and a filter to ignore entities.

16. A non-transitory machine-readable storage medium including instructions that, when executed by a machine, cause the machine to perform operations comprising:
providing a first user interface (UI) presenting one or more alerts related to log data received by an analysis platform, and
in response to a selection of an alert, providing a second UI, the second UI comprising one or more related alerts and a plurality of filters for selecting the one or more related alerts, the second UI comprising:
a first option, with a filter set and entity filters, for presenting the related alerts;
a second option, with the filter set, the entity filters and expansion parameters, for presenting the related alerts, wherein the expansion parameters add related alerts that are associated with information of the selected alert; and
a third option, with the filter set, the entity filters and artificial intelligence (AI) filters, for presenting the related alerts;
the AI filters providing matching scores for the related alerts, wherein the second UI shows related alerts with a match score greater than or equal to a score threshold.

17. The non-transitory machine-readable storage medium as recited in claim 16, wherein the machine further performs operations comprising:
in response to selecting one related alert in the second UI, presenting a comparison of information from the selected related alert and the selected alert.

18. The non-transitory machine-readable storage medium as recited in claim 16, wherein the machine further performs operations comprising:
calculating a matching score for each of the related alerts in the third option of the second UI, the matching score based on one or more partial entity matches and respective importance parameter values of the one or more partial entity matches.

19. The non-transitory machine-readable storage medium as recited in claim 16, wherein the machine further performs operations comprising:
providing, in the third option of the second UI, an option to change the score threshold; and
updating the one or more related alerts presented in the second UI after detecting a change in the score threshold.

20. The non-transitory machine-readable storage medium as recited in claim 16, wherein the third option of the second UI further includes a filter to select entities that are an exact match and a filter to ignore entities.
